(19) United States
(12) Patent Application Publication
(10) Pub. No.: US 2013/0111811 A1
(43) Pub. Date: May 9, 2013

(54) APPARATUS FOR COOLING PLANT

(71) Applicants: Shunsuke Miyauchi, Osaka-shi (JP); Toshihiro Ohta, Osaka-shi (JP); Takayuki Yuhki, Osaka-shi (JP)

(72) Inventors: Shunsuke Miyauchi, Osaka-shi (JP); Toshihiro Ohta, Osaka-shi (JP); Takayuki Yuhki, Osaka-shi (JP)

(73) Assignee: SHARP KABUSHIKI KAISHA, Osaka-shi, Osaka (JP)

(21) Appl. No.: 13/806,049

(22) PCT Filed: Jun. 20, 2011
(86) PCT No.: PCT/JP2011/064085

§ 371 Date: Dec. 20, 2012

(30) Foreign Application Priority Data
Jun. 25, 2010 (JP) 2010-145534

(51) Int. Cl. A01G 9/24; A01G 7/02; A01G 1/00

(52) U.S. Cl. CPC A01G 9/24; A01G 1/00; A01G 7/02
USPC 47/57.7

(57) ABSTRACT

A cooling apparatus (1) includes a cooling section (10) and at least one cooling gas supplying section (3) which (i) has at least one spout hole (34c) for spouting a cooling gas to the outside, and (ii) sprays the cooling gas, which has been supplied from cooling section (10), locally onto a plant (101) by spouting the cooling gas from the at least one spout hole (34c).

### TECHNICAL FIELD

The present invention relates to a plant cooling apparatus for locally cooling a plant by locally spraying a cooling gas onto the plant.

### BACKGROUND ART

In recent years, as agriculture attracts growing interest, (i) small-scale cultivation of a plant in a kitchen garden or the like and (ii) cultivation of a plant in a plant factory for cultivating the plant in a closed space, an environment of which is controlled, are attracting much interest.

In cultivation of a plant, temperature control is important. For example, it is known that locally cooling a part of a plant such as a strawberry plant accelerates a fruit-bearing process of the plant.

A conventionally known cooling apparatus for locally cooling a part of a plant includes, for example, a cooling apparatus described in Patent Literature 1.

FIG. 9 is a perspective view illustrating an arrangement of the cooling apparatus described in Patent Literature 1.

As illustrated in FIG. 9, the cooling apparatus described in Patent Literature 1 includes a water-permeable material 202 which is constituted by a thin layer, a sheet of paper, a cloth, or a sponge and is wound around a cooling pipe 201 over an entire length of the cooling pipe 201. A part of the water-permeable material 202 is cut open and unwound in the vicinity of a plant foot of a plant 101. According to Patent Literature 1, the part (unwound part 202a) of the water-permeable material 202 which part is unwound is spread out on compost 102, and an end of the unwound part 202a, which has been spread out, is brought into contact with a plant root part of the plant 101. Water is then supplied to the water-permeable material 202 so as to wet the water-permeable material 202. This causes the plant foot part of the plant 101 to be cooled by making use of latent heat of evaporation of water that evaporates from the unwound part 202a of the water-permeable material 202.

### CITATION LIST

### Patent Literature

Patent Literature 1
Japanese Patent Application Publication, Tokukai, No. 2010-4740 A (Publication Date: Jan. 14, 2010)

### SUMMARY OF INVENTION

### Technical Problem

However, a method as described in Patent Literature 1 may lead to an excess of water by keeping supplying water to the plant foot part of the plant 101 by means of the water-permeable material 202. In addition, bringing cooling water into direct contact with the plant foot part of the plant 101 by means of the water-permeable material 202 causes mold and disease damage to be generated more easily.

Further, in Patent Literature 1, the cooling pipe 201 and a water service pipe 203 are provided along a longitudinal direction of a compost tank 103, and the unwound part 202a of the water-permeable material 202, which unwound part 202a is brought into contact with the plant foot part of the plant 101, is supplied with water by use of (i) a drop of water obtained by running water through the cooling pipe 201 so as to cause water in the air to be condensed into the drop of water on a surface of the cooling pipe 201 and (ii) water dripped out of the water service pipe 203 which is provided so as to pass over an upper surface of the unwound part 202a of the water-permeable material 202. Because of this, it is only possible to cool the plant foot part of the plant 101.

However, the plant 101 has a growing point, at which cell division is actively carried out. Temperature control around the growing point is important in order to accelerate growth and a fruit-bearing process of the plant 101. A position of the growing point varies depending on a type of the plant 101, but in many cases, the growing point is at a tip of a stem. Note that in a case where the plant 101 is a strawberry plant, the growing point is in the vicinity of a crown part (part near a root, plant foot part) from which a leaf and a flower come out, and it is important to control a temperature around the crown part.

As such, the position of the growing point, that is, a height from a compost surface 102a (ground) to the growing point varies depending on (i) the type of the plant 101 and (ii) an extent to which the plant 101 grows.

Conventionally, since the growing point varies in this manner, temperature control of a culture solution is often carried out instead of temperature control of a part which originally is to be cooled or heated.

However, in a case where the culture solution of the plant 101 is thus cooled, there is a possibility that cooling a rhizome part prevents the plant 101 from growing.

The present invention is accomplished in view of the above problem. An object of the present invention is to provide a plant cooling apparatus which is capable of locally cooling a part of a plant without bringing cooling water into direct contact with the plant.

### Solution to Problem

In order to attain the object, a plant cooling apparatus in accordance with the present invention is a plant cooling apparatus for locally cooling a plant to be cultivated, including: a cooling gas supply source; and at least one cooling gas supplying section, each of which has at least one spout hole for spouting a cooling gas to an outside, and sprays the cooling gas, which has been supplied from the cooling gas supply source, locally onto the plant by spouting the cooling gas from the at least one spout hole.

Bringing the cooling water into direct contact with the plant causes (i) root rot resulting from an excess of water, (ii) mold, (iii) disease damage, and the like.

However, according to the present invention, the cooling gas is used to cool the plant, and the cooling water is not brought in direct contact with the plant. This makes it possible to prevent an excess of water and generation of mold and disease damage.

Further, in a case of (i) lowering, by cooling the air, a temperature of an environment in which the plant is cultivated or (ii) cooling the entire plant by cooling the air, there is a possibility that the plant becomes dry and the growth of the plant is inhibited, accordingly. However, as described above, in a case of locally cooling the plant by locally spraying the cooling gas supplying section onto the plant, it is possible to prevent the plant from becoming dry.

Further, the height from the compost surface to the growing point varies depending on the type of the plant or an extent to which the plant has grown. In a case where, in view of this, (i) a plant culture solution, temperature control of which can be easily carried out, is cooled instead of a part which originally is to be cooled or heated and (ii) the rhizome part is cooled by use of the plant culture solution thus cooled, growth of the plant may be inhibited.

However, according to the present invention, the plant is locally cooled by spraying the cooling gas onto the plant. This makes it possible to cool the plant locally irrespective of a shape of the plant or growth of the plant.

Further, spraying the cooling gas onto a surface of the plant as described above causes gas exchange on the surface of the plant to be activated due to (i) a flow of the cooling gas and (ii) an airflow generated by the flow of the cooling gas. This enhances efficiency in photosynthesis and efficiency in transpiration, so that growth can be accelerated.

That is, in a case where the air in the vicinity of the surface of the plant 101 does not move, (i) a composition of the air is imbalanced and (ii) efficiency in photosynthetic activity and efficiency in transpiration decrease, accordingly. This is because the plant does not voluntarily move. However, according to the present invention, it is possible to bring new air to the surface of the plant, so that an appropriate carbon dioxide concentration, an appropriate temperature, and an appropriate humidity can be maintained. This accelerates growth of the plant.

Further, according to the present invention, a large driving component such as a pump for introducing a liquid is not required, unlike Patent Literature 1. Therefore, according to the present invention, it is possible to provide a small and simplified plant cooling apparatus which can be put to household use.

### Advantageous Effects of Invention

As described above, a plant cooling apparatus in accordance with the present invention includes: a cooling gas supply source; and at least one cooling gas supplying section, each of which has at least one spout hole for spouting a cooling gas to an outside, and sprays the cooling gas, which has been supplied from the cooling gas supply source, locally onto the plant by spouting the cooling gas from the at least one spout hole. As such, the plant cooling apparatus in accordance with the present invention can locally cool a part of the plant without bringing cooling water into direct contact with the plant. This makes it possible to (i) prevent an excess of water and generation of mold and disease damage and (ii) cool the plant locally irrespective of a shape of the plant and growth of the plant.

Further, spraying the cooling gas onto a surface of the plant as described above causes gas exchange on the surface of the plant to be activated due to (i) a flow of the cooling gas and (ii) an airflow generated by the flow of the cooling gas. This enhances efficiency in photosynthesis and efficiency in transpiration, so that growth is accelerated.

Further, according to the present invention, a large driving component such as a pump for introducing a liquid is not required, unlike Patent Literature 1. Therefore, according to the present invention, it is possible to provide a small and simplified plant cooling apparatus which can be put to household use.

### BRIEF DESCRIPTION OF DRAWINGS

FIG. 1

FIG. 1 is a view schematically illustrating an entire arrangement of a cooling apparatus in accordance with an embodiment of the present invention.

FIG. 2

FIG. 2 is a view schematically illustrating an entire arrangement of a cooling apparatus in accordance with an embodiment of the present invention.

FIG. 3

FIG. 3 is a view schematically illustrating an example of an arrangement of main parts of a cooling apparatus in accordance with an embodiment of the present invention.

FIG. 4

(a) of FIG. 4 is a perspective view illustrating an outer appearance of a cooling gas supplying section of a cooling apparatus in accordance with an embodiment of the present invention. (b) of FIG. 4 is a plan view illustrating an arrangement of an inside of the cooling gas supplying section illustrated in (a) of FIG. 4.

FIG. 5

(a) and (b) of FIG. 5 are plan views each illustrating an example in which a shock-absorbing material is provided on an inner side wall of each of curved sections of the cooling gas supplying section illustrated in (a) and (b) of FIG. 4. (a) of FIG. 5 is a plan view corresponding to a case in which a plant between the curved sections has a relatively small diameter. (b) of FIG. 5 is a plan view corresponding to a case in which a plant between the curved sections has a relatively large diameter.

FIG. 6

FIG. 6 is a plan view illustrating a structure of the cooling gas supplying section in an area within the two-dot chain line in (b) of FIG. 5.

FIG. 7

(a) through (c) of FIG. 7 are views which illustrate in order how a cooling gas supplying section in accordance with another embodiment of the present invention is fixed to a plant.

FIG. 8

(a) through (e) of FIG. 8 respectively illustrate other examples of an arrangement of the cooling gas supplying section in accordance with the another embodiment of the present invention.

FIG. 9

FIG. 9 is a perspective view illustrating an arrangement of a cooling apparatus described in Patent Literature 1.

### DESCRIPTION OF EMBODIMENTS

The following description will discuss an embodiment of the present invention in detail.

### Embodiment 1

In cultivation of a plant, temperature control is very important. For example, locally cooling a part of a plant such as a strawberry plant accelerates a fruit-bearing process of the plant.

As such, in the present embodiment, growth of a plant is controlled by locally cooling a part of the plant.

<Entire Arrangement of Cooling Apparatus>

A cooling apparatus in accordance with the present embodiment is a plant cooling apparatus which cools a part of a plant by spraying a cooling gas (cold air) locally onto the plant. Note that the following description will be given, with reference to figures, on an example in which the plant cultivated is a strawberry plant. However, as a matter of course, the present embodiment is not limited to this, and can be suitably applied to cultivation of any plant.

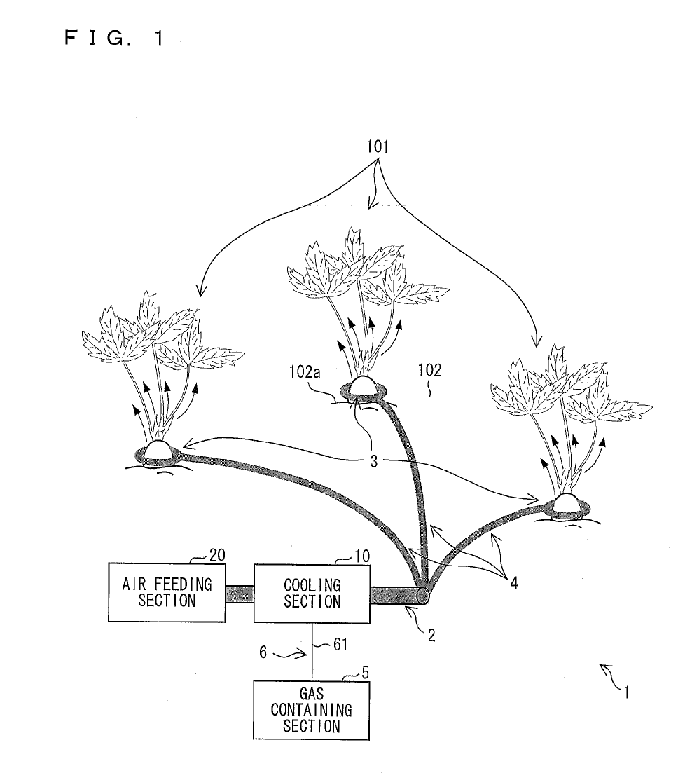

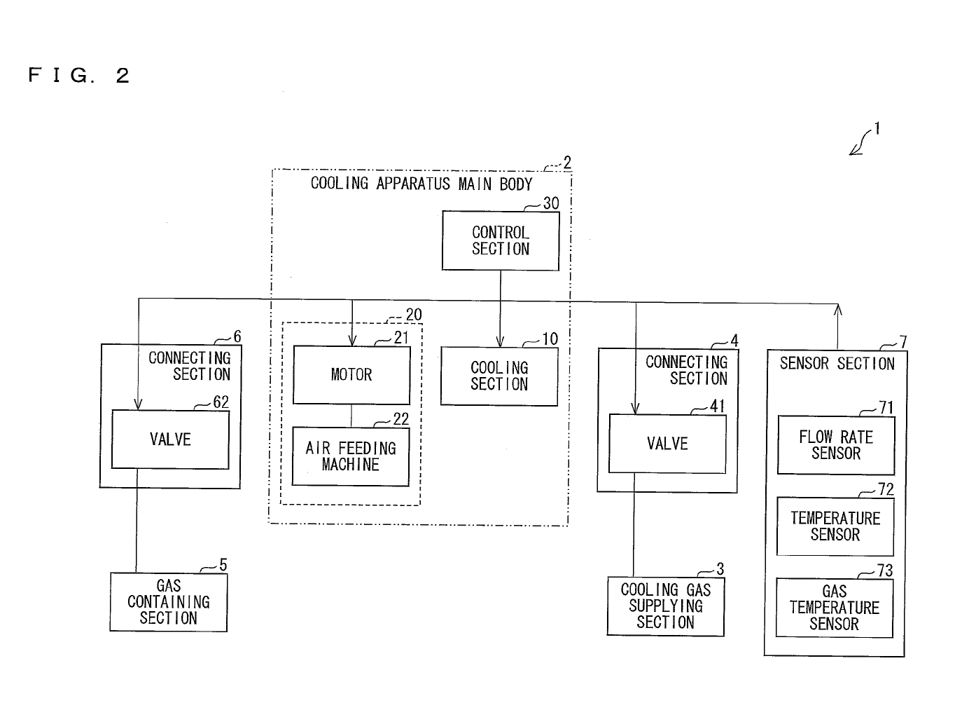

FIG. 1 is a view schematically illustrating an entire arrangement of the cooling apparatus in accordance with the present embodiment. FIG. 2 is a block diagram showing a relation of input and output of a signal in the cooling apparatus in accordance with the present embodiment.

As illustrated in FIG. 1, a cooling apparatus 1 in accordance with the present embodiment includes (i) a cooling apparatus main body 2 (housing), (ii) a cooling gas supplying section 3 (gas supplying tool) for spraying, onto the plant 101, a cooling gas supplied from the cooling apparatus main body 2, (iii) a connecting section 4 (cooling gas supplying connecting section, first connecting section) for connecting the cooling gas supplying section 3 with the cooling apparatus main body 2, (iv) a gas containing section 5 for containing a gas to be supplied to the cooling apparatus main body 2, (v) a connecting section 6 for connecting the gas containing section 5 with the cooling apparatus main body 2, and (vi) a sensor section 7 (see FIG. 2).

As illustrated in FIG. 2, the cooling apparatus main body 2 includes (i) a cooling section 10 for cooling a gas to be supplied to the plant 101, (ii) an air feeding section 20 for sending, from the cooling apparatus main body 2 to the cooling gas supplying section 3, the gas to be supplied to the plant 101, and (iii) a control section 30 for controlling driving each section of the cooling apparatus 1.

Next, the following description will discuss, in further detail, an arrangement and an operation of each section of the cooling apparatus 1.

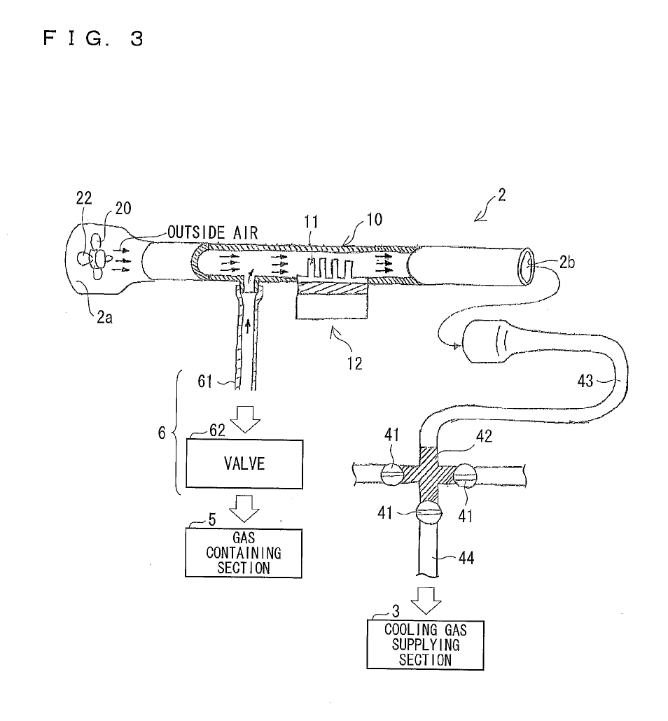

FIG. 3 is a view schematically illustrating an example of an arrangement of main parts of the cooling apparatus 1 in accordance with the present embodiment.

In the cooling apparatus 1 illustrated in FIG. 3, the gas contained in the gas containing section 5 flows into the cooling apparatus main body 2 via the connecting section 6, which connects the gas containing section 5 with the cooling apparatus main body 2. In the cooling apparatus main body 2, the gas is (i) mixed with outside air which has been sent from the outside by means of the air feeding section 20, and (ii) then transferred to the cooling section 10. The gas which has been transferred to the cooling section 10 is cooled in the cooling section 10 and then introduced, by means of the air feeding section 20, to the cooling gas supplying section 3 via the connecting section 4. Then, the gas is spouted to the outside from the cooling gas supplying section.

<Gas Containing Section 5>

The gas containing section 5 is a source of gas supply. The gas containing section 5 is, for example, a gas cylinder.

The cooling gas is mixed with outside air immediately after being spouted from the cooling gas supplying section 3. As such, the cooling gas is not limited to a specific one as long as it causes no damage to the plant 101 to be cultivated. Any gas other than a gas that causes damage to the plant 101 to be cultivated can be used as the cooling gas.

Note that a person skilled in the art has knowledge of gasses which cause damage to the plant 101 to be cultivated. Further, in cultivation of the plant 101 at home, gasses that are generally available and can be used are naturally limited. In particular, gasses that are available at a reasonable price in the cultivation of the plant 101 at home are even more limited. Therefore, it is impractical to list and specify, in order to exclude such a limited number of gasses, all gasses that can be used.

Accordingly, in the present embodiment, a type of the cooling gas is not specified. However, when availability and safety are taken into consideration, the cooling gas and the gas contained in the gas containing section 5 (these gasses are hereinafter collectively and simply referred to as “gas”) can be air, vapor, oxygen, nitrogen, carbon dioxide, an atmospheric ion, or a gaseous mixture of two or more types of gasses out of air, vapor, oxygen, nitrogen, carbon dioxide, and an atmospheric ion.

In particular, the gas is preferably a gaseous mixture containing at least one type of a gaseous component (active ingredient for plant cultivation) which is necessary for cultivation of a plant. Examples of the gaseous component encompass (i) carbon dioxide, which is necessary for the plant 101 in order to carry out photosynthesis, (ii) oxygen, which is necessary for the plant 101 in order to breathe, and (iii) the like.

Note that in a case where the cooling gas is air containing water vapor, a temperature of the cooling gas is preferably set higher than a dew point of the air. As a matter of course, the temperature of the cooling gas is set lower than a temperature of the outside air.

In a case where air is supplied to the cooling gas supplying section 3 as the cooling gas, the gas containing section 5 and the connecting section 6 are not necessarily needed. For example, it is possible to (i) lower, by means of the cooling section 10, a temperature of outside air (air) taken in by the air feeding section 20 and (ii) supply the outside air to the cooling gas supplying section 3. The outside air taken in by the air feeding section 20 into the cooling apparatus main body 2 is sent to the cooling section 10 after, if necessary, being mixed with a gas supplied from the gas containing section 5.

Note that even in a case where air is supplied to the cooling gas supplying section 3, an air cylinder that contains air (compressed air) can be used as the gas containing section 5 if necessary (e.g., in a case where it is necessary to maintain a pressure in a passage of the cooling gas, although it depends on, for example, a size (passage diameter and passage length) of each section which serves as the passage).

<Connecting Section 6>

The connecting section 6 (gas containing connecting section, second connecting section) includes (i) a gas pipe 61 for connecting the gas containing section 5 with the cooling apparatus main body 2 and (ii) a valve 62 provided in the gas pipe 61.

The gas pipe 61 is not limited to a specific one, provided that it has corrosion resistance against the gas which is contained in the gas containing section 5 and passes through the gas pipe 61. The gas pipe 61 can be publicly known various pipes that are conventionally used as gas pipes.

The valve 62 can be, for example, a solenoid valve. The valve 62 is not limited to a specific one, but in order to control a composition (gas concentration) of the cooling gas sent from the cooling apparatus main body 2 to the cooling gas supplying section 3, it is preferable that the valve 62 be capable of controlling (limiting) a flow rate of the gas introduced from the gas containing section 5 into the cooling apparatus main body 2.

Note that in a case where a plurality of gas containing sections 5 are provided (e.g., in a case of using, as the cooling gas, a gaseous mixture of a plurality of gasses or in a case of using a plurality of gases selectively by switching between the plurality of gasses), the valve 62 can be a multi-directional valve such as a three-way valve and a four-way valve, and does not necessarily have to be a two-way valve.

<Air Feeding Section 20>

As illustrated in FIG. 2, the air feeding section 20 includes an air feeding machine 22, and a motor 21 (air feeding machine driving section) for driving the air feeding machine 22.

The air feeding machine 22 is, for example, a fan as illustrated in FIG. 3. The cooling apparatus main body 2 has, for example, a tubular structure. The air feeding machine 22 is provided at, for example, a suction port 2a (outside air suction port) provided at one end of the cooling apparatus main body 2.

The air feeding machine 22 transfers (sends), toward the cooling section 10, outside air (air) which has been taken in by the air feeding machine 22 from the suction port 2a. By sending the air, the air feeding machine 22 causes a gas inside the cooling apparatus main body 2 to pass through the cooling apparatus main body 2 and be pushed out to the connecting section 4 from a supply opening 2b (gas exhaust port) provided at the other end of the cooling apparatus main body 2. Note that the air feeding machine 22 is caused to always operate.

In FIG. 3, the air feeding machine 22 is exemplified as a fan provided at the suction port 2a of the cooling apparatus main body 2, as described above. Note, however, that the present embodiment is not limited to this.

In place of the fan, for example, a blower, a pump, and the like can be suitably used as the air feeding machine 22 in a case where it is necessary to maintain a pressure in a passage of the cooling gas, although depending on a size (passage diameter and passage length) of each section which serves as the passage.

Further, the gas supplied from the gas containing section 5 into the cooling apparatus main body 2 does not necessarily have to be mixed with outside air in the cooling apparatus main body 2. As such, the cooling apparatus main body 2 can have an arrangement in which the one end serving as the suction port 2a is blocked up, provided that the air feeding section 20 can send the cooling gas from the cooling apparatus main body 2 to the cooling gas supplying section 3.

Further, a position at which the air feeding section 20 is provided is not limited to a specific position, provided that the air feeding section 20 can send the cooling gas from the cooling apparatus main body 2 to the cooling gas supplying section 3. The air feeding section 20 does not necessarily have to be provided within the cooling apparatus main body 2. For example, it is possible to use a T-shaped pipe as the gas pipe 61 in the connecting section 6 and cause the gas discharged into the gas pipe 61 to be sent to the cooling apparatus main body 2 by means of a pump, a blower, and the like.

<Cooling Section 10>

The cooling section 10 which serves as a source of cooling gas supply is, for example, a thermoelectric cooling device employing a Peltier device 12 which includes a cooling fin 11, as illustrated in FIG. 3.

The Peltier device 12 is obtained by bonding two types of semiconductor elements (P-type element and N-type element) via a metal electrode (not shown). The cooling fin 11 is provided in the cooling apparatus main body 2, and the metal electrode is exposed to an outside (i.e., outside of the housing) of the cooling apparatus main body 2, which serves as the housing.

In thermoelectric cooling device, in a case where an electric current is supplied from the P-type element to the N-type element when a gas passes through the cooling section 10 in the cooling apparatus main body 2, the Peltier effect causes the cooling fin 11 to absorb heat from the gas in the cooling section 10 and release the heat from the metal electrode.

Note that although the present embodiment has been discussed based on an example in which thermoelectric cooling device employing the Peltier device is used as the cooling section 10, the present embodiment is not limited to this.

The cooling device can be, for example, a cooling device (not shown) which (i) is constituted by a heat sink (radiator) which is included in the cooling apparatus main body 2 and made from a highly heat-conductive metal such as aluminum or copper and (ii) cools the gas by applying the gas to the heat sink by use of a gas flow, generated by the air feeding machine 22, inside the cooling apparatus main body 2. Alternatively, it is possible to use a forced-cooling device constituted by a heat sink and a cooling fan provided on the heat sink.

It is also possible to use a water-cooling type cooling device which cools the gas by use of water, which has a heat capacity larger than that of air, so as to carry out heat exchange by (i) bringing a head for circulating the water into contact with the gas transferred to the cooling section 10, so that heat of the gas is taken away via the water and (ii) releasing the heat by means of a radiator provided outside the cooling apparatus main body 2.

<Connecting Section 4>

The connecting section 4 is used as a passage of the cooling gas which is sent from the cooling apparatus main body 2 to the cooling gas supplying section 3. As such, the connecting section 4 includes, as illustrated in FIGS. 2 and 3, (i) a branch pipe 42 (branch section) which is used as a joint and provided with a valve 41, (ii) a coupling pipe 43 for coupling the supply opening 2b of the cooling apparatus main body 2 and the branch pipe 42 to each other, and (iii) a flexible pipe 44 for connecting the branch pipe 42 with the cooling gas supplying section 3.

As illustrated in FIG. 1, the cooling apparatus 1 in accordance with the present embodiment includes a plurality of cooling gas supplying sections 3 and is capable of simultaneously cooling a plurality of plants 101 by means of a single cooling apparatus 1.

In a case where the plurality of cooling gas supplying section 3 are connected with the cooling apparatus main body 2 in this manner, the branch pipe 42 having a plurality of branch sections is used as the joint.

Note that FIG. 1 shows an example in which three cooling gas supplying sections 3 are connected with the cooling apparatus main body 2. As such, in the present embodiment, a four-way valve which divides a passage of the cooling gas into three ways is used as the joint (i.e., the branch pipe 42 provided with the valves 41 in the example illustrated in FIG. 3).

Note that, in accordance with the number of cooling gas supplying sections 3 to be connected, the joint (coupling section) which connects the coupling pipe 43 with the flexible pipe 44 can be a multi-directional valve such as a five-way valve and a six-way valve, provided that the joint is capable of coupling flexible pipes 44 the number of which is equal to the number of the cooling gas supplying sections 3 to be connected. Note that by blocking up some of a plurality of valves 41 provided in the branch pipe 42, it is also possible to limit, in accordance with the number of the plants 101, the number of cooling gas supplying sections 3 to be used among the cooling gas supplying sections 3 connected with the connecting section 4.

Further, the number of the cooling gas supplying sections 3 provided does not necessarily have to be more than one. In a case where only one cooling gas supplying section 3 is provided, the joint is not necessarily needed. However, for the purpose of, for example, controlling (i) a flow rate of the cooling gas and (ii) timing for supplying the cooling gas, it is possible to use a two-way valve as the joint.

In the present embodiment, “flexible pipe” denotes a pipe having flexibility. Examples of the flexible pipe 44 encompass a gas tube such as an air tube. Note, however, that the flexible pipe 44 is not limited to this, and can be a gas hose. That is, a pipe diameter of the flexible pipe 44 can be set appropriately in accordance with a flow rate of the cooling gas or the like, and is not limited to a specific one.

Further, a length (passage length) of the flexible pipe 44 can also be set appropriately in accordance with (i) a distance between the plant 101 and the cooling apparatus main body 2, (ii) a type of the plant 101 (in particular, a height into which the plant grows), and (iii) the like, and is not limited to a specific one.

A material of the flexible pipe 44 is not limited to a specific one, provided that it has flexibility and corrosion resistance against the cooling gas passing through the flexible pipe 44. Examples of the flexible pipe 44 can encompass (i) a resin pipe made from a synthetic resin such as vinyl and (ii) a metal pipe made from a thin metal. Further, the flexible pipe 44 can be a straight pipe, a bellows pipe, or a coil pipe. Note that use of the bellows pipe or the coil pipe as the flexible pipe 44 allows a length of the flexible pipe 44 to be changed as the plant 101 grows in a height direction of the plant 101.

As illustrated in FIG. 3, the coupling pipe 43 is provided so that (i) one end of the coupling pipe 43 is engaged with the supply opening 2b of the cooling apparatus main body 2 and (ii) the other end of the coupling pipe 43 is engaged with the branch pipe 42, which serves as the joint. Note that in a case where no joint is provided, the coupling pipe 43 and the flexible pipe 44 can be integrally formed by use of a flexible material. In this case, the other end is formed so as to be engaged with the cooling gas supplying section 3.

Note, however, that in a case where the joint is provided as described above, a part of the coupling pipe 43 which part constitutes the passage does not necessarily have to have flexibility, provided that the part has corrosion resistance against the cooling gas passing though the coupling pipe 43.

Note that the coupling pipe 43 of the connecting section 4 can be coupled to (engaged with) the supply opening 2b of the cooling apparatus main body 2 and with the branch pipe 42 in such a manner that the supply opening 2b and the branch pipe 42 are each fitted into or screwed into the coupling pipe 43. The flexible pipe 44 of the connecting section 4 can be coupled to (engaged with) the branch pipe 42 and with the cooling gas supplying section 3 in such a manner that the branch pipe 42 and the cooling gas supplying section 3 are each fitted into or screwed into the flexible pipe 44.

<Sensor Section 7>

The sensor section 7 is a detecting section for detecting a flow rate, a temperature, and a gas concentration of the cooling gas supplied to the plant 101. As illustrated in FIG. 2, the sensor section 7 includes (i) a flow rate sensor 71 for measuring a flow rate of the cooling gas supplied to the cooling gas supplying section 3, (ii) a temperature sensor 72 for measuring a temperature of the cooling gas supplied to the cooling gas supplying section 3, and (iii) a gas concentration sensor 73 for measuring a gas concentration (composition) of the cooling gas supplied to the cooling gas supplying section 3. Note that a commercially available, general-purpose sensor can be used as each of the flow rate sensor 71, the temperature sensor 72, and the gas concentration sensor 73.

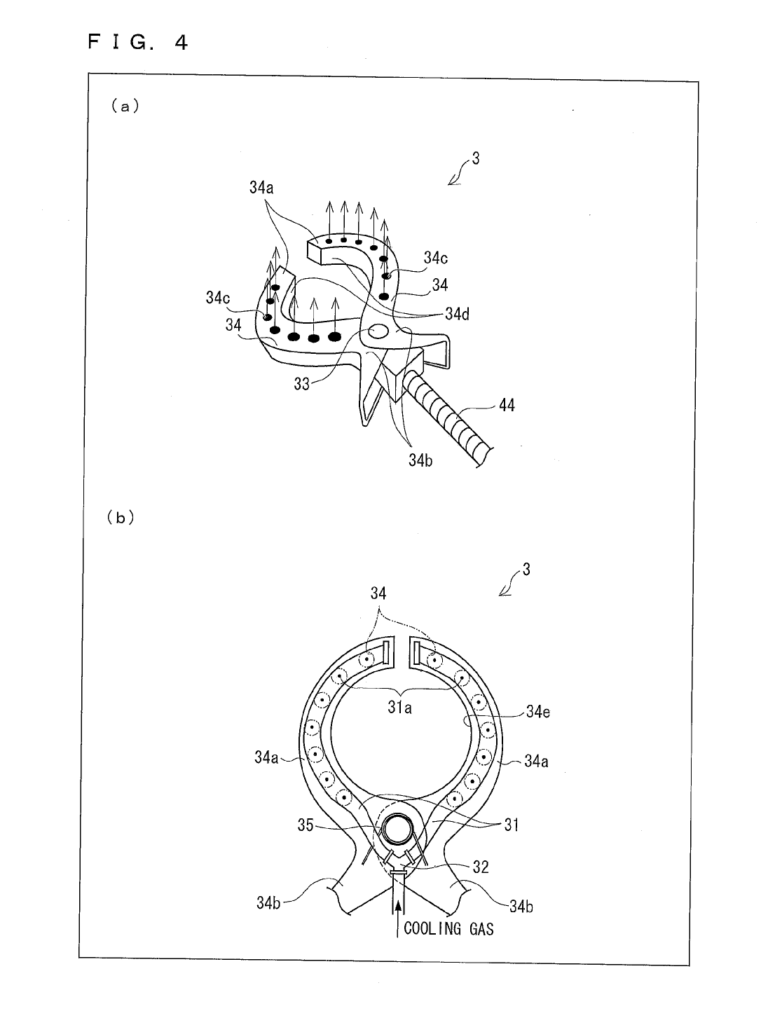

The flow rate, the temperature, and the gas concentration of the cooling gas are each measured at a part of the cooling gas which part has passed through the branch pipe 42 serving as the branch section. As such, it is preferable that each of the flow rate sensor 71, the temperature sensor 72, and the gas concentration sensor 73 be provided in the vicinity of a spout hole 34c (see (a) and (b) of FIG. 4) for the cooling gas. Note, however, that each of the flow rate sensor 71, the temperature sensor 72, and the gas concentration sensor 73 can be provided at a part of a passage of the cooling gas which has passed through the branch pipe 42.

That is, the sensor section 7 can be provided in the connecting section 6. In this case, the flow rate, the temperature, and the gas concentration of the cooling gas are measured by inserting the flow rate sensor, the concentration sensor, and the temperature sensor into a pipe that constitutes a passage of the cooling gas.

However, as described above, by (i) providing the flow rate sensor, the concentration sensor, and the temperature sensor in the vicinity of the spout hole 34c for the cooling gas, (ii) detecting physical properties as described above (i.e., flow rate, temperature, and gas concentration) of the cooling gas supplied from the cooling gas supplying section 3 to the plant 101, and (iii) controlling each section of the cooling apparatus 1 on the basis of a result of detection thus carried out, it is possible to control each section further precisely.

In the cooling apparatus 1, it is preferable that (i) the physical properties of the cooling gas be detected as described above and (ii) the result of detection be used, as feedback, in control of each section of the cooling apparatus 1. Note, however, that the sensor section 7 does not necessarily have to be provided. In a case where measurement by means of the sensor section 7 is not carried out and feedback is not given, it is possible to have a less expensive arrangement.

<Control Section 30>

As illustrated in FIG. 2, the control section 30 controls driving each section of the cooling apparatus 1. The control section 30 includes (i) a valve opening and closing control section (not shown) for controlling the valve 41 and the valve 62 to open and close, (ii) a motor driving control section (not shown) for controlling driving the motor 21, (iii) a cooling device driving control section (not shown) for controlling driving the cooling section 10, and (iv) the like.

The result of detection of the physical properties, which detection has been carried by the sensor section 7, is transmitted to the control section 30. On the basis of the result of detection of the physical properties, the control section 30 transmits a control signal to each of the valve 41, the valve 62, the motor 21, and the cooling section 10 so that the physical properties of the cooling gas are desired values.

In this manner, the control section 30 carry out, on the basis of the result of detection carried out by means of the sensor section 7, control of, for example, a rotation rate of the fan (the air feeding machine 22), an amount of an electric current in the Peltier device 12, and opening and closing of the solenoid valve (valves 41 and 62). That is, for example, the control section 30 controls a temperature of the cooling gas to be supplied to the plant 101 by carrying out an ON-OFF control of the cooling section 10 in accordance with a temperature of the cooling gas which temperature has been detected by the temperature sensor 72.

Note that a condition of supplying the cooling gas, i.e., the physical properties of the cooling gas to be supplied to the plant 101, is not limited to a specific condition, and can be appropriately set in accordance with a type of the plant 101 and the like.

For example, in a case where the plant 101 is a strawberry plant, flower bud differentiation is accelerated at a temperature of 0 C.° to 5 C.°, but a temperature environment that is required varies depending on a type of a plant and a growth stage. According to an experiment, an appropriate supply rate (flow rate) is 0.3 m/s to 0.8 m/s. Note that a flow rate near 0.8 m/s is preferable in consideration of a slowdown after spouting. The flow rate of the cooling gas is determined on the basis of a flow rate and a pipe diameter.

<Cooling Gas Supplying Section 3>

(a) of FIG. 4 is a perspective view illustrating an outer appearance of the cooling gas supplying section 3 in the cooling apparatus 1 in accordance with the present embodiment. (b) of FIG. 4 is a plan view illustrating an arrangement of an inside of the cooling gas supplying section 3 illustrated in (a) of FIG. 4. Note that for easy illustration, a cover member is illustrated with a two-dot chain line in (b) of FIG. 4.

In (a) and (b) of FIG. 4, the cooling gas supplying section 3 in accordance with the present embodiment has a clip structure.

The cooling gas supplying section 3 includes (i) a pair of flexible pipes 31 for spouting the cooling gas which has passed through the connecting section 4, each of the pair of flexible pipes 31 having the plurality of spout holes 31a, (ii) a three-way pipe 32 (Y-shaped pipe) for coupling each of the pair of flexible pipes 31 with the flexible pipe 44 of the connecting section 4, (iii) a pair of pinching members 34 which are used as a cover member for covering the pair of flexible pipes 31 and are connected with each other so as to be openable and closable about an opening and closing axis 33 as a fulcrum, and (iv) a spring 35 for urging each of the pair of pinching members 34 in a certain direction so that the pair of pinching members carry out pinching (close).

A flexible pipe similar to the flexible pipe 44 can be used as each of the pair of flexible pipes 31, except that each of the flexible pipes 31 (i) has the plurality of spout holes 31a for spouting the cooling gas and (ii) has a length in accordance with a curved section 34a of a corresponding one of the pair of pinching members 34, which serve as the cover member (i.e., a length that allows each of the flexible pipes 31 to be housed in the curved section 34a).

The three-way pipe 32 is provided before the opening and closing axis 33 in the passage of the cooling gas, and is used as a branch section for causing the passage of the cooling gas supplied to the cooling gas supplying section 3 to branch. One end of the three-way pipe 32 is coupled (engaged) with the flexible pipe 44 of the connecting section 4, as described above. Each of the other two ends is coupled with a corresponding one of the pair of flexible pipes 31. Note that (i) engagement (method for coupling) between the flexible pipe 44 and the three-way pipe 32 and (ii) engagement (method for coupling) between each of the pair of flexible pipes 31 and the three-way pipe 32 are not limited to a specific one. As described above, the three-way pipe 32 can be fitted into or screwed into the flexible pipe 44, and the three-way pipe 32 can be fitted into or screwed into each of the pair of flexible pipes 31.

The pair of pinching members 34 (fixing member, clip main body) are bilaterally symmetrical, and each of the pair of pinching members 34 includes a curved section 34a (pinching section, fixing section) and a gripping section 34b. The opening and closing axis 33 is provided between the curved section 34a and the gripping section 34b.

The spring 35 is an urging member for urging the pair of pinching members 34 so that ends of the respective curved sections 34a of the pair of pinching members 34 are in contact with each other or in proximity with each other. Note that the spring 35 can have a linear shape or a thin plate-like shape.

The curved sections 34a are curved outward and function as a fixing section for fixing the cooling gas supplying section 3 to the plant 101 by pinching the plant 101 by means of an urging force of the spring 35.

When the pair of gripping sections 34b of the respective pinching members 34 are gripped (i.e., when forces are applied in directions which cause respective ends of the gripping sections 34b to approach each other), the gripping sections 34b function as points of application of force for applying, to the spring 35, forces for causing the curved sections 34a, which have been closed by means of the urging force of the spring 35, to open about the opening and closing axis 33 as a fulcrum. That is, gripping the pair of gripping sections 34b causes the pair of gripping sections 34b to act in a direction that causes the pair of curved sections 34a to open.

On one surface of each of the curved sections 34a of the pinching members 34, a plurality of spout holes 34c are formed. The plurality of spout holes 34c spray the cooling gas, which has been spouted into the pinching member 34 from the spout hole 31a of the flexible pipe 31, to the plant 101 by spouting the cooling gas to the outside. In an example as illustrated in (a) and (b) of FIG. 4, the spout holes 34c are holes (through holes) which are provided in a part (hereinafter referred to as “upper cover”) which covers an upper surface of the flexible pipe 31 when the cooling gas supplying section 3 is fixed to the plant 101. The holes are arranged in a circle in a plan view.

The curved sections 34a of the pinching members 34 are curved outward as described above, and have a cylindrical gap in a central part of the curved sections 34a in a state where the curved sections 34a are closed (a state where the pinching members 34 are urged in a direction that causes ends of the respective curved sections 34a of the pair of pinching members 34 to be in contact with each other or in the vicinity of each other).

That is, the cooling gas supplying section 3 has an opening section 34e between the pair of pinching members 34, which an opening section 34e is formed by the curved sections 34a which are curved outward. The plant 101 is contained in the opening section 34e (gap between the curved sections 34a of the pinching members 34).

As such, the cooling gas supplying section 3 has an arrangement in which the spout holes 34c are formed at intervals so as to surround the plant 101. This allows the cooling gas supplying section 3 to spray, from around the plant 101 to which the cooling gas supplying section 3 is fixed, the cooling gas over an entire diameter of the plant 101. This allows the cooling gas supplying section 3 to cool the plant 101 uniformly over an entire circumference of the plant 101.

As described above, in the present embodiment, (i) the spout holes 34c are formed, for example, in a circle in a plan view, in each of the curved sections 34a of a clip (i.e., the cooling gas supplying section 3 having a clip-like shape) which is fixed to the plant 101 by means of an urging force (spring force) of the spring, and (ii) the cooling gas is spouted from the spout holes 34c. The cooling gas (i) is supplied from the three-way pipe 32, which is provided at a root part of the clip, to the inside of the clip via the flexible pipe 31, and (ii) is spouted from the spout holes 34c on the surface of the clip.

Bringing the cooling water into direct contact with the plant 101 causes (i) root rot resulting from an excess of water, (ii) mold, (iii) disease damage, and the like.

However, in the present embodiment, the plant 101 is locally cooled by locally spraying the cooling gas to the plant 101, as described above. This makes it possible to prevent an excess of water and generation of mold, disease damage, and the like.

Note that although the cooling gas spouted from the spout holes 34c locally cools the plant 101 immediately after being spouted, the cooling gas will soon have a temperature equal to that of the outside air. As such, the cooling gas does not affect temperatures of other parts of the plant 101.

Since cooling water is not used (i.e., the cooling water is not brought in direct contact with the plant 101) in a cooling method according to the present embodiment, the present embodiment can be flexibly put to various uses.

Further, according to the present embodiment, the cooling gas supplying section 3 has a clip structure and is fixed to the plant 101 by means of an urging force of the spring 35. This allows the cooling gas supplying section 3 to be fixed to the plant 101 with an appropriate force.

In a case where the cooling gas supplying section 3 is fixed to the plant 101 in this manner, a position of the cooling gas supplying section 3 fixed to the plant 101 moves with respect to the compost surface 102a, as the plant 101 grows. This makes it possible to (i) change, in accordance with growth of a plant, the position of the cooling gas supplying section 3 with respect to the compost surface 102a and (ii) prevent deviation of a place to be cooled.

Further, by fixing the cooling gas supplying section 3 to the plant 101 in this manner, it is possible to easily and uniformly cool a part of the plant 101 which part is to be cooled.

That is, for example, in a case where (i) a supporting member such as a supporting base is provided in the vicinity of the plant 101, (ii) a nozzle for jetting the cooling gas is fixed to the supporting member by means of a clip, a screw, or the like so that the nozzle is located in the vicinity of the plant 101 so as to face the plant 101, and (iii) the cooling gas is sprayed from the nozzle toward the plant 101 in such a manner that the cooling gas is sprayed laterally or obliquely from one direction, there are (i) a direction in which the cooling gas jetted from the nozzle goes and (ii) another direction in which the cooling gas jetted from the nozzle does not go, the another direction being opposite to the direction in which the cooling gas jetted from the nozzle goes.

However, in a case where, as described above, the cooling gas supplying section 3 is fixed to the plant 101 so that the spout holes 34c surround the plant 101, it is possible to uniformly cool, for example, a growing point of the plant 101.

Further, unlike in a case where (i) a temperature of an environment in which the plant 101 is cultivated is lowered or (ii) the entire plant 101 is cooled, it is necessary, in order to locally cool the plant 101, that the spout holes 34c of the cooling gas be provided in the vicinity of a part of the plant 101 which part is to be cooled.

However, as the plant 101 grows, the plant 101 not only extends in a height direction but also expands radially (in a diameter direction).

As such, for example, in a case where (i) the supporting member for the nozzle for jetting the cooling gas is provided in the vicinity of the plant 101 and (ii) the nozzle is fixed to the supporting member, it is necessary, in order to prevent the nozzle and the supporting member from becoming an obstacle to growth of the plant 101, that the nozzle and the supporting member be moved as the plant 101 grows. However, such an operation requires time and effort. As such, the operation is not practical in a case where the number of plants 101 is large.

Further, in a case where the nozzle and the supporting member are provided with a sufficient distance from the plant 101 in anticipation of growth of the plant 10, a range in which the cooling gas is diffused increases as the distance between the nozzle and the plant 101 increases. This makes it difficult to uniformly cool a part of the plant 101 which part is to be cooled.

However, as described above, fixing the cooling gas supplying section 3 to the plant 101 allows the position of the cooling gas supplying section 3 to be changed in accordance with growth of the plant 101. This makes it possible to easily and uniformly cool the part of the plant 101 which part is to be cooled. It also becomes possible to enhance an effect of local cooling.

Further, in a case of (i) lowering, by cooling air, a temperature of an environment in which the plant 101 is cultivated or (ii) cooling the entire plant 101 by cooling air, there is a possibility that the plant 101 becomes dry and the growth of the plant 101 is inhibited, accordingly.

However, as described above, in a case of locally cooling the plant 101 by locally spraying the cooling gas supplying section 3 onto the plant 101, it is possible to prevent the plant 101 from becoming dry.

Further, according to the present embodiment, by (i) using, as the cooling gas, air which contains water vapor and/or (ii) controlling the flow rate and the temperature of the cooling gas in a spout hole 34c, it is possible to achieve a condition under which the plant 101 neither becomes dry nor is inhibited from growing. Note that in a case where the flow rate and the temperature of the cooling gas in the spout hole 34c are controlled, the smaller a distance between the spout hole 34c and the plant 101 is, a more stable control (with little fluctuations in accordance with a location) can be carried out. Therefore, also in view of this, it is preferable that the cooling gas supplying section 3 be fixed to the plant 101.

Further, since the cooling gas supplying section 3 has the clip structure as described above, it is possible to apply the present embodiment to a plant 101 having a wide range of diameters, without inhibiting growth (increase in diameter) of the plant 101.

Note that in the present embodiment, a position at which the cooling gas is supplied to the plant 101 is not limited to a specific one. However, the plant 101 has a growing point at which cell division is actively carried out. Temperature control around the growing point is important in order to accelerate growth and a fruit-bearing process of the plant 101.

Accordingly, in order to accelerate the growth and the fruit-bearing process of the plant 101, it is preferable to cool the growing point of the plant 101 by spraying the cooling gas onto the growing point of the plant 101.

As such, it is preferable that the cooling gas supplying section 3 be fixed at a position at or in the vicinity of the growing point of the plant 101, at which position the cooling gas supplying section 3 can cool the growing point of the plant 101.

A position of the growing point varies depending on a type of the plant 101. In many cases, the growing point is located at a tip of a stem. In a case where the plant 101 is a strawberry plant as illustrated in FIG. 1, the growing point is located in the vicinity of a crown part (part near a root, plant foot part) from which a leaf and a flower come out.

FIG. 1 illustrates an example in which the cooling gas supplying section 3 is fixed to a crown part of a strawberry plant, which is the plant 101.

When the compost surface 102a (ground) is a reference position, a position (i.e., height from the compost surface 102a to the growing point) of the growing point with respect to the compost surface 102a varies depending on the type of the plant 101 or an extent to which the plant 101 has grown. Since the position of the growing point with respect to a reference point varies (moves) in this manner, conventionally, temperature control of a culture solution is often carried out instead of temperature control of a part which originally is to be cooled or heated, as described above.

However, cooling the culture solution of the plant 101 in this manner so as to cool a rhizome part by use of the culture solution thus cooled may inhibit growth of the plant 101.

In the present embodiment, the plant 101 is locally cooled by spraying the cooling gas to a part of the plant 101 in stead of cooling the plant 101 by (i) cooling the culture solution as described above or (ii) bringing cooling water in contact with the plant foot part of the plant 101 as described in Patent Literature 1. This makes it possible to locally cool the plant 101 irrespective of a shape of the plant 101 and an extent to which the plant 101 has grown.

That is, according to the cooling apparatus described in Patent Literature 1, (i) a drop of water into which water in the air has been condensed by means of the cooling pipe 201 and (ii) water dripped out of the water service pipe 203 which is provided so as to pass over the upper surface of the unwound part 202a are supplied to the unwound part 202a of the water-permeable material 202 which is wound around the cooling pipe 201 provided on the compost 102. In this manner, the plant foot part of the plant 101 is cooled by use of latent heat of evaporation of water which is evaporated from the unwound part 202a. As such, the cooling apparatus of Patent Literature 1 can only cool the plant foot part of the plant 101 and is not suitable for service when the plant 101 has grown. By contrast, according to the present embodiment, spraying the cooling gas to a part of the plant 101 as described above makes it possible to change a position to be cooled.

Further, in the present embodiment, the cooling gas supplying section 3 is fixed to the plant 101 and, as described above, the flexible pipe 44 is used as the connecting section 4. Accordingly, the position to be cooled can be changed in accordance with growth of the plant 101. This makes it possible to easily cool a desired position even when the plant has grown.

Further, spraying the cooling gas onto a surface of the plant 101 as described above causes gas exchange on the surface of the plant 101 to be activated due to (i) a flow of the cooling gas and (ii) an airflow generated by the flow of the cooling gas. This enhances efficiency in photosynthesis and efficiency in transpiration, so that growth is accelerated.

In particular, since, as described above, the cooling gas supplying section 3 (i) has the clip structure and (ii) has the spout holes 34c which surround the plant 101, an air flow is generated in a ring formed by a clip surrounding the plant 101. This makes it possible to further activate the gas exchange on the surface of the plant 101.

The plant 101 does not voluntarily move. As such, in a case where the air in the vicinity of the surface of the plant 101 does not move, (i) a composition of the air is imbalanced and (ii) efficiency in photosynthetic activity and efficiency in transpiration decrease, accordingly. It is known that in an experiment in which air is actually blown to the plant 101, photosynthetic activity and wind velocity are correlated until the wind velocity reaches a certain velocity. This is why an advice to “put the plant 101 at a well-ventilated place” is generally given in a case of growing the plant 101.

That is, “gas exchange” in the present embodiment means delivering new air to a surface of the plant 101. By delivering new air to the surface of the plant 101, it is possible to maintain an appropriate carbon dioxide concentration, an appropriate temperature, and an appropriate humidity. This accelerates growth of the plant 101.

Further, the cooling apparatus described in Patent Literature 1 has a structure in which the cooling pipe 201 and the water service pipe 203 are provided along a longitudinal direction of the compost tank 103. Cooling water such as tap water or well water is run through the cooling pipe 201, and a nutrient solution to be applied to the plant 101 is run through the water service pipe 203. As such, the cooling apparatus of Patent Literature 1 requires a large driving component such as a pump for (i) running a liquid such as the cooling water through the cooling pipe 201 and (ii) running a liquid such as the nutrient solution through the water service pipe 203. Accordingly, the cooling apparatus of Patent Literature 1 is not only large and inflexible, but also requires time and effort in adjustment and maintenance of the cooling apparatus.

Further, in Patent Literature 1, the plant 101 is cooled by supplying the cooling water by use of the unwound part 202a of the water-permeable material 202. This results in lack of durability and reliability. Further, in order to replace the water-permeable material 202 when the water-permeable material 202 is damaged, it is necessary to (i) rewind a water-permeable material 202 around the cooling pipe 201 and (ii), for the purpose of forming the unwound part 202a, unwind the water-permeable material 202 in the vicinity of the plant foot of the plant 101. Because of this, the cooling apparatus of Patent Literature 1 takes time for maintenance despite that the cooling apparatus has poor durability.

By contrast, according to the present embodiment, it is possible to cause the gas to flow by use of the air feeding machine 22 such as a fan, as described above. As such, the present embodiment does not require a large driving component such as a pump for introducing a liquid, unlike Patent Literature 1 which requires the pump for introducing a liquid, such as the cooling water and the nutrient solution, into the cooling pipe 201 and into the water service pipe 203. Moreover, the cooling apparatus in accordance with the present embodiment includes a smaller number of driving sections, so that the cooling apparatus can be designed smaller than a conventional cooling apparatus. Therefore, according to the present embodiment, it is possible to provide a small and simplified cooling apparatus (cultivation apparatus) which can be put to household use.

Note that a shock-absorbing material (shock-absorbing member), a heat-conductive material (heat conducting member), and/or the like can be provided on a surface of each of the curved sections 34a, which surface faces the plant 101. That is, the shock-absorb material, the heat-conductive material, and/or the like can be provided on each of side walls (hereinafter referred to as “inner side walls”) 34d of the respective curved sections 34a, which side walls constitute inner side walls of the opening section 34e and face each other.

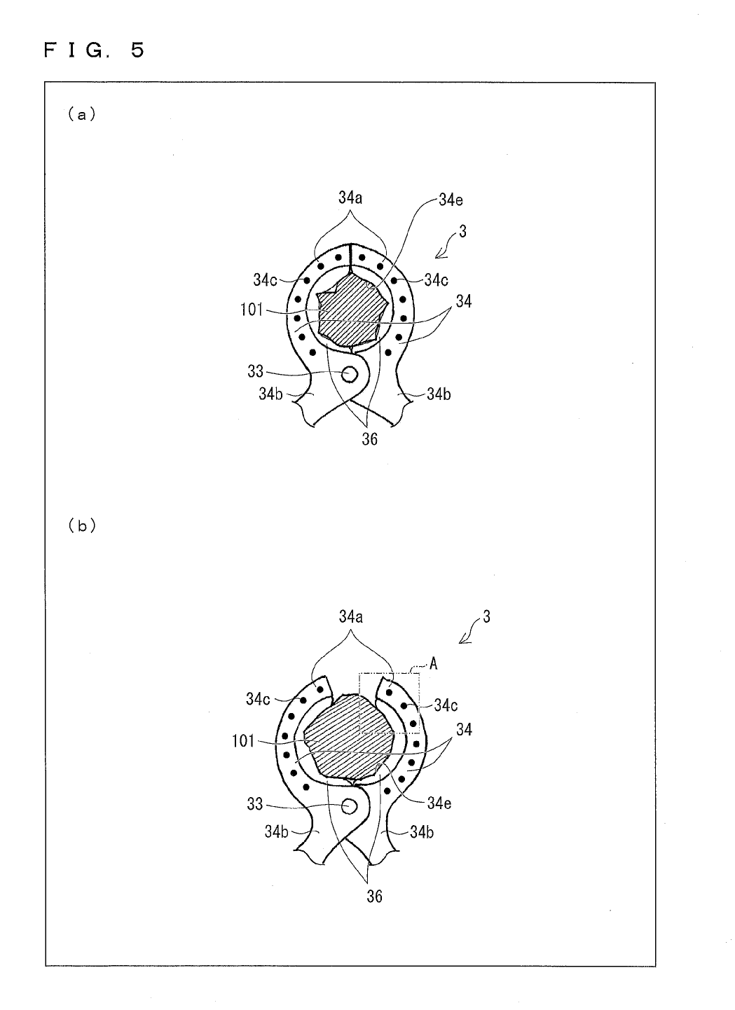

(a) and (b) of FIG. 5 are plan views each illustrating an example in which a shock-absorbing material 36 is provided on each of the inner side walls 34d of the curved sections 34a. (a) of FIG. 5 is a plan view corresponding to a case in which the plant 101 between the curved sections 34a has a relatively small diameter. (b) of FIG. 5 is a plan view corresponding to a case in which the plant 101 between the curved sections 34a has a relatively large diameter.

More specifically, (a) of FIG. 5 illustrates an example of how the cooling gas supplying section 3 is fixed to the plant 101 in a case where the plant 101 between the curved sections 34a has a diameter smaller than a diameter of the opening section 34e when the curved sections 34a are closed, and (b) of FIG. 5 illustrates an example of how the cooling gas supplying section 3 is fixed to the plant 101 in a case where the plant 101 between the curved sections 34a has a diameter larger than a diameter of the opening section 34e when the curved sections 34a are closed.

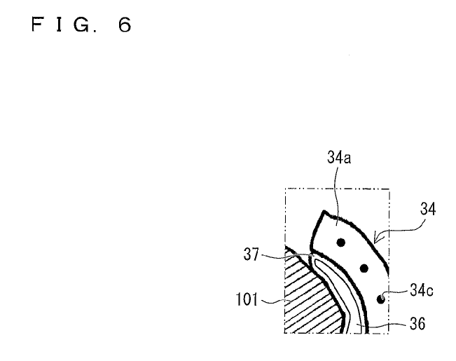

FIG. 6 is a plan view illustrating a structure of the cooling gas supplying section 3 in an area A within the two-dot chain line in (b) of FIG. 5. FIG. 6 illustrates an example in which a heat-conductive material 37 is provided on a surface of the shock-absorbing material 36.

Examples of the shock-absorbing material 36 can encompass (i) resin foam of polyurethane, polystyrene, polyethylene, or the like, (ii) an elastomer, and (iii) the like.

Providing the shock-absorbing material 36 on the inner side walls 34d of the curved sections 34a, as illustrated in (a) and (b) of FIG. 5 and FIG. 6, makes it possible to conform to unevenness in the surface of the plant 101. This allows the cooling gas supplying section 3 to be firmly fixed to the plant 101, even in a case where the surface of the plant 101 is uneven. Further, no damage is given to a part of the plant 101 where the cooling gas supplying section 3 is fixed to the plant 101.

A plant 101 diameter that allows the cooling gas supplying section 3 to be fixed to the plant 101 is determined in accordance with (i) an opening diameter of the opening section 34e (i.e., a diameter of the gap between the inner side walls 34d) in a state where the curved sections 34a are closed and (ii) an opening diameter of the opening section 34e in a state where the curved sections 34a are opened as wide as possible.

However, by providing, as described above, the shock-absorbing material 36 having elasticity on each of the inner side walls 34d of the curved sections 34a, it is possible to respond to a change in diameter of the plant 101 within a range of thickness of the shock-absorbing material 36, though it depends on a type of the shock-absorbing material 36. As such, even in a case where the plant 101 to which the cooling gas supplying section 3 is to be fixed has a diameter smaller than a diameter of the opening section 34e in a state where the curved sections 34a are closed, it is possible to fix the cooling gas supplying section 3 to the plant 101. This allows the cooling apparatus to be applied to a wider range of plants 101.

Examples of the heat-conductive material 37 encompass a graphite sheet, silicone rubber, and the like, each of which has a high thermal conductivity. It is preferable that, as illustrated in FIG. 6, the heat-conductive material 37 cover the shock-absorbing material 36 so as to be in contact with (i) a surface of the shock-absorbing material 36 which surface is to be in contact with each of the inner side walls 34d of the curved sections 34a and (ii) a surface of the shock-absorbing material 36 which surface is to be in contact with the plant 101. This increases conductivity of cold air, so that the plant 101 can be cooled efficiently.

Note that the present embodiment has been discussed based on an example in which, as described above, on the upper cover which covers the upper surface of the flexible pipe 31 when the cooling gas supplying section 3 is fixed to the plant 101, the spout holes 34c, which are arranged in a circle in a plan view, are provided, so that the cooling gas is spouted upward from the spout holes 34c.

However, the present embodiment is not limited to this. Since a stoma of a plant is on a backside of a leaf, gas exchange needs to be carried out on the backside of the leaf. As such, the example above is advantageous in that spraying the cooling gas upward as described above, rather than downward, makes it easier for the cooling gas to reach the backside of the leaf spout.

Further, the present embodiment has been discussed based on an example in which the plant 101 is a strawberry plant. As such, spraying the cooling gas downward may swirl up mold and bacteria on the compost surface 102a. However, the present embodiment is not limited to this in a case where, for example, a tip of the plant 101 is cooled. In this case, spraying the cooling gas downward toward a center part of the plant 101 is more advantageous because efficiency in gas exchange is improved.

### Embodiment 2

In the present embodiment, another example of arrangement of the cooling gas supplying section 3 will be described. Note that the present embodiment will be described only in terms of a difference between the present embodiment and Embodiment 1. For easy explanation, the same reference signs will be given to members each having the same function as a member illustrated in the figures of Embodiment 1, and descriptions on such a member will be omitted.

### Example 1

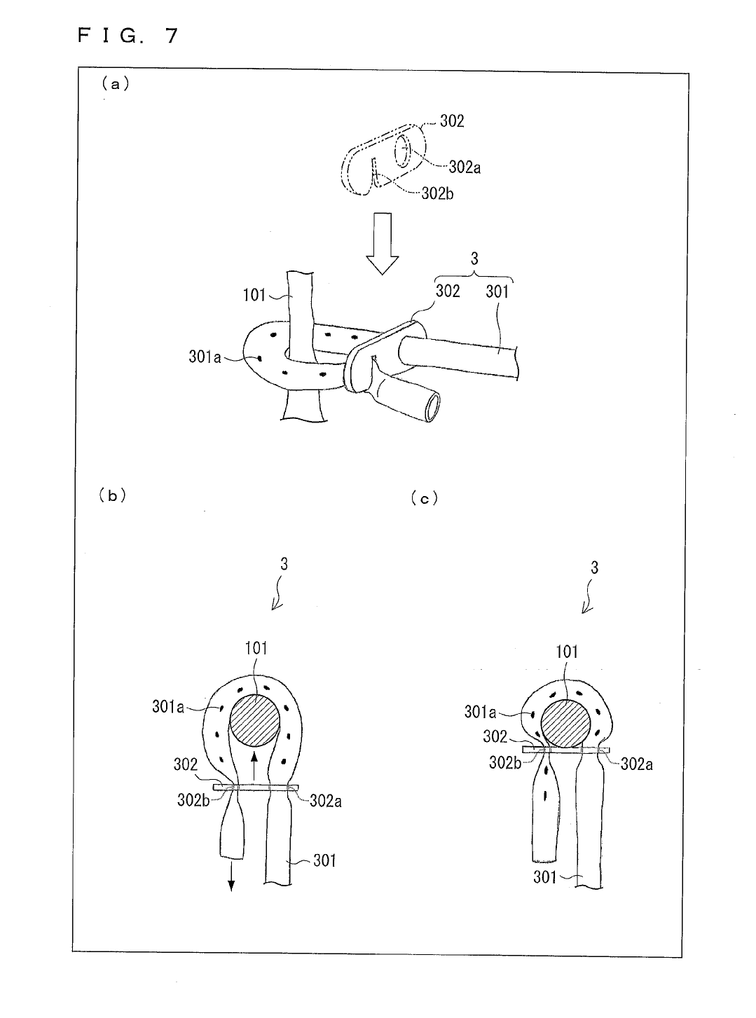

(a) through (c) of FIG. 7 are views which illustrate in order how the cooling gas supplying section 3 in accordance with the present embodiment is fixed to the plant 101.

As illustrated in (a) through (c) of FIG. 7, the cooling gas supplying section 3 in accordance with the present embodiment includes (i) a flexible pipe 301 having a plurality of spout holes 301a for spouting the cooling gas to the outside and (ii) a fastening member 302 which is a fixing member for fixing the flexible pipe 301 to the plant 101.

The fastening member 302 is a clip member for fixing the flexible pipe 301 to the plant 101 in such a manner that (i) the fastening member 302 holds the flexible pipe 301 in a state where the flexible pipe 301 is wound around the plant 101 like a ring, and (ii) a size of the ring formed by the flexible pipe 301 is adjusted.

As illustrated in (a) of FIG. 7, the fastening member 302 has (i) an insertion hole 302a (pipe insertion hole) which holds the flexible pipe 301 inserted through the insertion hole 302a and (ii) a fit hole 302b (pipe-fitted hole, slit) for holding the flexible pipe 301 in such a manner that the flexible pipe 301 inserted through the insertion hole 302a and wound around the plant 101 so as to form a ring is fitted into the fit hole 302b. Fitting the flexible pipe 301 into the fit hole 302b in this manner so as to fix and seal the flexible pipe 301 prevents the cooling gas from continuing on along the flexible pipe 301 beyond the fit hole 302b.

In order to fix the flexible pipe 301 to the plant 101, first, as illustrated in (a) of FIG. 7, the flexible pipe 301 is inserted through the insertion hole 302a of the fastening member 302 and wound around the plant 101 so as to form a ring. In this state, the flexible pipe 301 is fitted into the fit hole 302b of the fastening member 302. Subsequently, as illustrated in (b) of FIG. 7, an end of the flexible pipe 301 is pulled away from the plant 101 so that a distance between the fastening member 302 and the plant 101 is reduced. This causes the ring formed by the flexible pipe 301 to become smaller so that, as illustrated in (c) of FIG. 7, the fastening member 302 touches the plant 101. This allows the flexible pipe 301 to be fixed to the plant 101.

As described above, in the example illustrated in (a) through (c) of FIG. 7, a force with which the flexible pipe 301 is fixed to the plant 101 can be adjusted by adjusting a position where the flexible pipe 301 is fitted into the fastening member 302.

In the example illustrated in (a) through (c) of FIG. 7, the flexible pipe 301 wound around the plant 101 so as to form a ring is used as a cooling gas supplying section main body (trunk section). As such, a length (diameter) of the ring can be changed freely in accordance with a diameter of the plant 101. It is therefore possible to apply the example illustrated in (a) through (c) of FIG. 7 to a plant 101 of any size by changing (adjusting) the diameter of the ring.

Further, since the plant 101 is cooled by use of the flexible pipe 301 in a ring shape, the spout holes 301a provided so as to surround the plant 101 allows the plant 101 to be cooled uniformly over an entire circumference of the plant 101, even if the plant 101 grows.

The figures in the present embodiment illustrate a case in which one end of the flexible pipe 301 is open, which one end is located downstream of the other end in a direction in which the cooling gas flows. Note, however, that the present embodiment is not limited to this. As described above, the flexible pipe 301 is fitted into the fit hole 302b so as to be fixed and sealed. This prevents the cooling gas from continuing on along the flexible pipe 301 beyond the fit hole 302b. Therefore, the one end of the flexible pipe 301 which one end is located downstream of the other end in the direction in which the cooling gas flows can be open or not open.

### Example 2

Note that an arrangement of the cooling gas supplying section 3 having the spout holes via which the cooling gas is spouted and a method for fixing the cooling gas supplying section 3 to the plant 101 are not limited to the illustrations above.

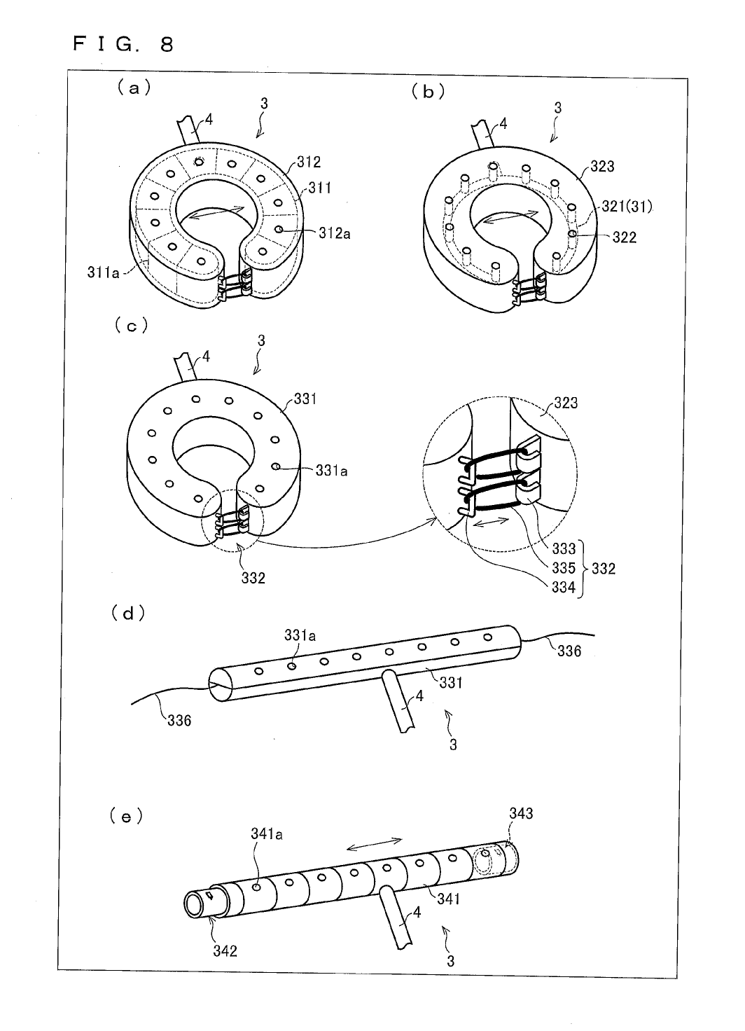

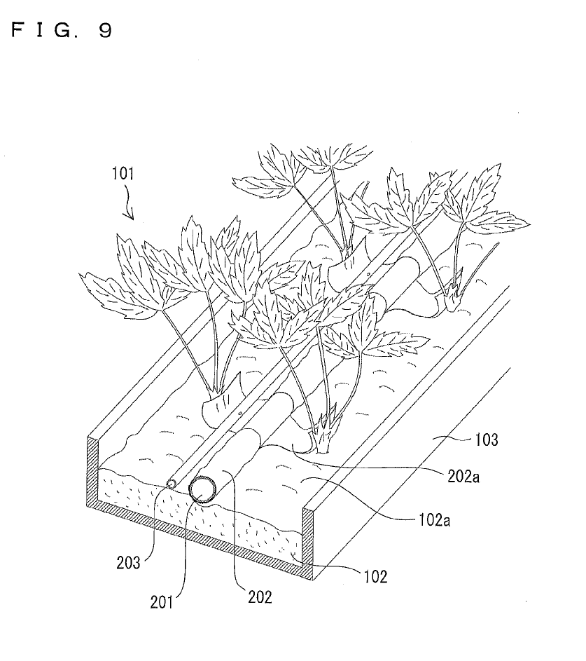

(a) through (e) of FIG. 8 respectively illustrate other examples of an arrangement of the cooling gas supplying section 3.

A cooling gas supplying section 3 as illustrated in (a) of FIG. 8 has a double bag structure made up of (i) a C-shaped (concave), bubble shock-absorbing material 311 which contains gas such as air and is known by such names as air cushion (registered trademark) and air bag (registered trademark), and (ii) a cover bag 312 which covers the bubble shock-absorbing material 311 and has spout holes 312a via which the cooling gas is spouted.

The cooling gas supplying section 3 as illustrated in (a) of FIG. 8 is fixed to the plant 101 by utilizing an elastic deformation (elastic strain) of the bubble shock-absorbing material 311 which is C-shaped, as described above.

The cooling gas introduced from the connecting section 4 to the cooling gas supplying section 3 is (i) passed through a gap between the bubble shock-absorbing material 311 and the cover bag 312, which covers the bubble shock-absorbing material 311 and has spout holes 312a for spouting the cooling gas to the outside, and (ii) then spouted from the spout holes 312a.

That is, in the example illustrated in (a) of FIG. 8, the gap between the bubble shock-absorbing material 311 and the cover bag 312 is used as a passage.

Note that in order that the bubble shock-absorbing material 311 has strength, the bubble shock-absorbing material 311 can have a cell structure in which, for example, a plurality of air cells (cells 311a) are connected, as indicated by the two-dot chain lines in (a) of FIG. 8.

Note that neither the cover bag 312 nor the bubble shock-absorbing material 311 is limited to a specific material. The cover bag 312 and the bubble shock-absorbing material 311 can each be made from any material provided that the material (i) has flexibility, corrosion resistance against the cooling gas to be used, and sufficient strength to withstand fluid pressure generated when the cooling gas is introduced into the passage, and (ii) allows the cooling gas to diffuse throughout the passage. Examples of a material of the cover bag 312 and examples of a material of the bubble shock-absorbing material 311 encompass a synthetic resin such as vinyl, but are not specifically limited to this.

### Example 3

A cooling gas supplying section 3 as illustrated in (b) of FIG. 8 has a cooling gas supplying section main body 323 (trunk section) which is hollow and constituted by an elastic member and has (i) a continuous hole 321 which serves as a passage for the cooling gas and (ii) spout holes 322 which communicate with the continuous hole 321 and from which the cooling gas is spouted to the outside.

The cooling gas supplying section main body 323 has a C shape (concave shape) and is fixed to the plant 101 by utilizing an elastic deformation (elastic strain) of the cooling gas supplying section main body 323 which has elasticity.

The cooling gas supplying section main body 323 can be made from, for example, an elastic material such as rubber. Note, however, that a material of the cooling gas supplying section main body 323 is not limited to this, and can be any material provided that it (i) has elasticity and corrosion resistance against the cooling gas to be used and (ii) allows the cooling gas to be diffused throughout the continuous hole 321.

Note that in a case where the cooling gas supplying section main body 323 is thus made from the elastic material, it is desirable to adjust a shape of each of the spout holes 322, a modulus of elasticity (coefficient of elasticity), or the like so as to prevent the spout holes 322 from being blocked due to elastic deformation.

Further, a flexible pipe 31 as used in Embodiment 1 can be inserted in the continuous hole 321. That is, the cooling gas supplying section main body 323 can have an arrangement in which the flexible pipe 31 which serves as a passage for the cooling gas is covered with the elastic material.

In this case, it is not necessary that the cooling gas supplying section main body 323 be made from a gas-impermeable material in order to diffuse the cooling gas throughout the continuous hole 321. The cooling gas supplying section main body 323 can be made from an elastic material (foam material), such as urethane foam, which has air permeability (air hole). Note that in this case, pores of the elastic material which communicates with the spout holes 31a (see (b) of FIG. 4) of the flexible pipe 31 can be used as the spout holes 322.

Note that although (a) and (b) of FIG. 8 show cases in each of which a fixation tool similar to a fixation tool 332 illustrated in (c) of FIG. 8 (described later) is provided, the fixation tool is not necessarily indispensable.

### Example 4

(c) of FIG. 8 illustrates an example in which a stretchable fixing member is used to fix a cooling gas supplying section 3 to the plant 101.

The cooling gas supplying section 3 illustrated in (c) of FIG. 8 includes (i) a cooling gas supplying section main body 331 having spout holes 331a for spouting the cooling gas to the outside and (ii) the fixation tool 332 for fixing the cooling gas supplying section main body 331 to the plant 101.

The fixation tool 332 includes (i) a hook 333 provided on one end of the cooling gas supplying section main body 331, (ii) a hook receiver 334 provided on the other end, and (iii) a stretch member 335 provided between the hook 333 and the hook receiver 334.

Note that the cooling gas supplying section main body 331 (trunk section) is not limited to a specific one, provided that it (i), as described above, has the spout holes 331a for spouting the cooling gas to the outside, (ii) has flexibility, and (iii) is capable of pinching the plant 101.

The cooling gas supplying section main body 331 can have a structure illustrated in (a) of FIG. 8. Further, in the structure illustrated in (a) of FIG. 8, it is possible to have an arrangement in which the cover bag 312 contains, for example, a flexible pipe 31 as used in Embodiment 1, in place of the bubble shock-absorbing material 311. The cooling gas supplying section main body 331 does not necessarily have to have elasticity as illustrated in (a) of FIG. 8, provided that it has flexibility.

Examples of the stretch member 335 encompass a stretchable member (elastic member) which is made from a stretchable material such as rubber and has a shape of a ring or a string.

Each of the cooling gas supplying sections 3 illustrated in (a) and (b) of FIG. 8 has the cooling gas supplying section main body (trunk section) made from an elastic material, and the cooling gas supplying section 3 is fixed to the plant 101 by utilizing an elastic deformation of the cooling gas supplying section main body. That is, the cooling gas supplying section main body itself functions as an urging member (urging means).

However, as described above, a part of the fixation tool 332 is the stretch member 335 which serves as urging means. As such, even in a case where the cooling gas supplying section main body 331 does not have elasticity, (i) the cooling gas supplying section main body 331 can be fixed to the plant 101 and (ii), since the stretch member 335 stretches as the plant 101 grows, it is possible for the cooling gas supplying section 3 to adjust its shape in accordance with the growth of the plant 101. This eliminates the need of adjusting or replacing a member as the plant 101 grows.

### Example 5

A cooling gas supplying section 3 illustrated in (d) of FIG. 8 is another example in which a stretching fixing member is used to fix the cooling gas supplying section 3 to the plant 101.

The cooling gas supplying section 3 illustrated in (d) of FIG. 8 includes (i) a cooling gas supplying section main body 331 having spout holes 331a for spouting the cooling gas to the outside, and (ii) a fixing string 336 for fixing the cooling gas supplying section main body 331 to the plant 101.

The cooling gas supplying section main body 331 (trunk section) can have the same arrangement as that of the cooling gas supplying section main body 331 illustrated in (c) of FIG. 8.

In the cooling gas supplying section 3 illustrated in (d) of FIG. 8, the cooling gas supplying section main body 331 is provided with the fixing string 336 as a fixation tool.

Note that the fixing string 336 is not limited to a particular length and a particular material. In a case where the fixing string 336 is made from a stretching material (stretching string member) such as a rubber string, the stretching material (the stretch member 335) extends as the plant 101 grows. As such, like the example illustrated in (c) of FIG. 8, it is possible to change a position of the cooling gas supplying section 3 in accordance with growth of the plant 101 even in a case where the cooling gas supplying section main body 331 does not have elasticity, the plant 101.

### Example 6

A cooling gas supplying section 3 illustrated in (e) of FIG. 8 is an example in which a cooling gas supplying section main body (trunk section) is stretchable and elastic, so that the cooling gas supplying section 3 is fixed to the plant 101.

The cooling gas supplying section 3 illustrated in (e) of FIG. 8 includes a cooling gas supplying section main body 341 having spout holes 341a for spouting the cooling gas to the outside. The cooling gas supplying section main body 341 is constituted by a bellows pipe, and can be wound around and fixed to the plant 101 in such a manner that one of both ends of the cooling gas supplying section main body 341 is fitted into the other one of the both ends so that the cooling gas supplying section main body 341 forms a ring.

It is preferable that the cooling gas supplying section main body 341 include, at both ends of the cooling gas supplying section main body 341, a pair of engagement members 342 and 343 which are engaged with each other. By causing the pair of engagement members 342 and 343 to be engaged with each other, it is possible to prevent the cooling gas supplying section 3, which is fixed to the plant 101, from being released from the plant 101 due to (i) pressing force generated by growth of the plant 101 contained within the ring or (ii) fluid pressure of the cooling gas flowing in the cooling gas supplying section main body 341. Note that a method of causing the engagement members 342 and 343 to be engaged with each other is not limited to a specific one. It is possible to employ various well-known methods such as engagement (fitting) by use of an engagement claw.

Note that the bellows pipe of the cooling gas supplying section main body 341 is not limited to a particular material and structure, provided that (i) the bellows pipe is stretchable and elastic and (ii), in a state where the bellows pipe forms a ring, the bellows pipe can extend as the plant 101 grows and expands radially. Note, however, that in order to prevent a diameter of each of the spout holes 341a from changing due to radial expansion of the plant 101, it is desirable that the cooling gas supplying section main body 341 have an extension part and a non-extension part, and the spout holes 341a be provided in the non-extension part.

Note that Embodiments 1 and 2 have been discussed based an example in which the cooling gas supplying section 3 has a plurality of spout holes. The plurality of spout holes are preferably provided so as to surround the plant 101, as described above. However, the present invention is not limited to this. In terms of locally cooling a part of the plant without bringing the cooling water into direct contact with the plant, at least one spout hole should be provided.

### CONCLUSION

As described above, the plant cooling apparatus as described in the above embodiments is a plant cooling apparatus for locally cooling a plant to be cultivated, including: a cooling gas supply source; and at least one cooling gas supplying section, each of which has at least one spout hole for spouting a cooling gas to an outside, and sprays the cooling gas, which has been supplied from the cooling gas supply source, locally onto the plant by spouting the cooling gas from the at least one spout hole.

According to the arrangement, the cooling gas is used to cool the plant, and cooling water is not brought in direct contact with the plant. This makes it possible to prevent an excess of water and generation of mold, disease damage, and the like.

Further, since the plant is cooled locally by spraying the cooling gas onto the plant, it is possible to cool the plant locally irrespective of a shape of the plant and growth of the plant.

Moreover, spraying the cooling gas onto a surface of the plant as described above causes gas exchange on the surface of the plant to be activated due to (i) a flow of the cooling gas and (ii) an airflow generated by the flow of the cooling gas. This enhances efficiency in photosynthesis and efficiency in transpiration, so that growth can be accelerated.

That is, in a case where the air in the vicinity of the surface of the plant does not move, (i) a composition of the air is imbalanced and (ii) efficiency in photosynthetic activity and efficiency in transpiration decrease, accordingly. This is because the plant does not voluntarily move. However, according to the present invention, it is possible to bring new air to the surface of the plant, so that an appropriate carbon dioxide concentration, an appropriate temperature, and an appropriate humidity can be maintained. This accelerates growth of the plant.

Further, the plant cooling apparatus does not require a large driving component such as a pump for introducing a liquid, unlike Patent Literature 1. Therefore, according to the above arrangement, it is possible to provide a small and simplified plant cooling apparatus which can be put to household use.

The plant cooling apparatus is preferably arranged such that: each of the at least one cooling gas supplying section includes a fixing member for fixing each of the at least one cooling gas supplying section to the plant.

In a case where each of the at least one cooling gas supplying section is fixed to the plant in this manner, a position of each of the at least one cooling gas supplying section fixed to the plant moves with respect to the compost surface, as the plant grows. This makes it possible to (i) change, in accordance with growth of the plant, the position of each of the at least one cooling gas supplying section with respect to the compost surface and (ii) prevent deviation of a place to be cooled. It also becomes possible to enhance an effect of local cooling.

Further, in a case where a flow rate and a temperature of the cooling gas in a spout hole are controlled, the smaller a distance between the spout hole and the plant is, a more stable control (with little fluctuations in accordance with a location) can be carried out. Therefore, also in view of this, it is preferable that each of the at least one cooling gas supplying section be fixed to the plant.

Further, the plant cooling apparatus is preferably arranged such that: each of the at least one cooling gas supplying section includes a cooling gas supplying section main body which is hollow and has the at least one spout hole; the at least one spout hole is a plurality of spout holes which are arranged in a row along a length of the cooling gas supplying section main body; and the fixing member fixes the cooling gas supplying section main body to the plant so that the cooling gas supplying section main body surrounds the plant.

Fixing each of the at least one cooling gas supplying section to the plant in this manner makes it possible to easily and uniformly cool a part to be cooled, for example, a growing point of the plant and the like.

Further, the plant cooling apparatus is preferably arranged such that: the cooling gas supplying section main body includes a pair of pinching members, each of which has a curved section which is curved outward, the pair of pinching members (i) being coupled to each other so as to be openable and closable and (ii) pinching the plant by means of the curved sections; the plurality of spout holes are provided in each of the curved sections of the pair of pinching members; and the fixing member is an urging member for urging each of the pair of pinching members in a certain direction so that the pair of pinching members pinch the plant.

That is, each of the at least one cooling gas supplying section preferably has a clip structure in which the pair of pinching members are urged by the urging member.

As the plant grows, the plant not only extends in a height direction but also expands radially.

Since each of the at least one cooling gas supplying section has the clip structure as described above, it is possible to not only change a position of each of the at least one cooling gas supplying section in accordance with radial growth of the plant as well as growth of the plant in the height direction. That is, according to the arrangement, it is possible to apply the plant cooling apparatus to a plant having a wide range of diameters, without inhibiting growth (increase in diameter) of the plant.

Further, in a case where (i) each of the at least one cooling gas supplying section has the clip structure as described above and (ii) the spout holes are provided so as to surround the plant, a flow of air is generated in a ring of a clip that surrounds the plant. This makes it possible to further activate the gas exchange on the surface of the plant.

Further, the plant cooling apparatus is preferably arranged such that: a surface of each of the pair of pinching members, which surface faces the plant, is provided with a shock-absorbing material.

According to the above arrangement, it is possible to firmly fix each of the at least one cooling gas supplying section to the plant even in a case where the surface of the plant is uneven. In addition, no damage is given to a part of the plant where each of the at least one cooling gas supplying section is fixed to the plant.

Further, the plant cooling apparatus is preferably arranged such that: a surface of each of the pair of pinching members, which surface faces the plant, is provided with a heat-conductive material so that the surface and the heat-conductive material are in contact with each other.

According to the above arrangement, it is possible to increase conductivity of cold air, so that the plant can be cooled efficiently.

Further, the plant cooling apparatus is preferably arranged such that: the cooling gas supplying section main body is constituted by a pipe which is flexible and has the plurality of spout holes; and the fixing member is a fastening member which (i) has a pipe insertion hole and a pipe-fitted hole and (ii) blocks up one end of the pipe, which one end is located downstream of the other end of the pipe in a direction in which the cooling gas flows, in such a manner that the pipe inserted through the pipe insertion hole is fitted into the pipe-fitted hole in a state where the pipe forms a ring so as to surround the plant.

According to the above arrangement, a force with which the pipe (flexible pipe) having flexibility is fixed to the plant can be adjusted by adjusting a position where the flexible pipe is fitted into the fastening member. Further, according to the above arrangement, the flexible pipe in a form of a ring is used as a cooling gas supplying section main body (trunk section). As such, a length (diameter) of the ring can be changed freely in accordance with a diameter of the plant. It is therefore possible to apply the plant cooling apparatus to a plant of any size by changing (adjusting) the diameter of the ring.

Further, the plant cooling apparatus is preferably arranged such that: a connecting section for connecting the cooling gas supply source with each of the at least one cooling gas supplying section includes at least one flexible pipe.

According to the above arrangement, thus using the flexible pipe in the connecting section makes it possible to change, in accordance with growth of the plant in the height direction, a position at which each of the at least one cooling gas supplying section is fixed to the plant. Accordingly, even if the plant grows, a desired position can be easily cooled.

Further, the plant cooling apparatus is preferably arranged such that: the connecting section includes a branch section which (i) causes a passage of the cooling gas, which is supplied from the cooling gas supply source to each of the at least one cooling gas supplying section, to branch, and (ii) is provided with the at least one flexible pipe; and each of the at least one cooling gas supplying section is connected with a corresponding one of the at least one flexible pipe connected with the branch section.

According to the above arrangement, it is possible to cool a plurality of plants simultaneously.

The present invention is not limited to the above-described embodiments but allows various modifications within the scope of the claims. Any embodiment obtained by appropriately combining the technical means disclosed in the different embodiments will also be included in the technical scope of the present invention.

### INDUSTRIAL APPLICABILITY

The present invention can be applied to a plant cooling apparatus for locally cooling a plant.

### REFERENCE SIGNS LIST

1: cooling apparatus (plant cooling apparatus)
2: cooling apparatus main body
2a: suction port
2b: supply opening
3: cooling gas supplying section
4: connecting section
5: gas containing section
6: connecting section
7: sensor section
10: cooling section (cooling gas supply source)
11: cooling fin
12: Peltier device
20: air feeding section
21: motor
22: air feeding machine
30: control section
31: flexible pipe
31a: spout hole
32: three-way pipe
33: opening and closing axis
34: pinching member
34a: curved section
34b: gripping section
34c: spout hole
34e: opening section
34d: inner side wall
35: spring
36: shock-absorbing material
37: heat-conductive material
42: branch pipe
43: coupling pipe
44: flexible pipe
61: gas pipe
71: flow rate sensor
72: temperature sensor
73: gas concentration sensor
101: plant
102: compost
102a: compost surface
301: flexible pipe
301a: spout hole
302: fastening member
302a: insertion hole (pipe insertion hole)
302b: fit hole (pipe-fitted hole)
311: bubble shock-absorbing material
311a: cell
312: cover bag
312a: spout hole
321: continuous hole
322: spout hole
323: cooling gas supplying section main body
331: cooling gas supplying section main body
331a: spout hole
332: fixation tool
333: hook
334: hook receiver
335: stretch member
336: fixing string
341: cooling gas supplying section main body
341a: spout hole
342: engagement member
343: engagement member

1. A plant cooling apparatus for locally cooling a plant to be cultivated, comprising:
a cooling gas supply source; and
at least one cooling gas supplying section, each of which has at least one spout hole for spouting a cooling gas to an outside, and sprays the cooling gas, which has been supplied from the cooling gas supply source, locally onto the plant by spouting the cooling gas from the at least one spout hole.

2. The plant cooling apparatus as set forth in claim 1, wherein:
each of the at least one cooling gas supplying section includes a fixing member for fixing each of the at least one cooling gas supplying section to the plant.

3. The plant cooling apparatus as set forth in claim 2, wherein:
each of the at least one cooling gas supplying section includes a cooling gas supplying section main body which is hollow and has the at least one spout hole;
the at least one spout hole is a plurality of spout holes which are arranged in a row along a length of the cooling gas supplying section main body; and
the fixing member fixes the cooling gas supplying section main body to the plant so that the cooling gas supplying section main body surrounds the plant.

4. The plant cooling apparatus as set forth in claim 3, wherein:
the cooling gas supplying section main body includes a pair of pinching members, each of which has a curved section which is curved outward, the pair of pinching members (i) being coupled to each other so as to be openable and closable and (ii) pinching the plant by means of the curved sections;
the plurality of spout holes are provided in each of the curved sections of the pair of pinching members; and
the fixing member is an urging member for urging each of the pair of pinching members in a certain direction so that the pair of pinching members pinch the plant.

5. The plant cooling apparatus as set forth in claim 4, wherein:
a surface of each of the pair of pinching members, which surface faces the plant, is provided with a shock-absorbing material.

6. The plant cooling apparatus as set forth in claim 4, wherein:
a surface of each of the pair of pinching members, which surface faces the plant, is provided with a heat-conductive material so that the surface and the heat-conductive material are in contact with each other.

7. The plant cooling apparatus as set forth in claim 3, wherein:
the cooling gas supplying section main body is constituted by a pipe which is flexible and has the plurality of spout holes; and
the fixing member is a fastening member which (i) has a pipe insertion hole and a pipe-fitted hole and (ii) blocks up one end of the pipe, which one end is located downstream of the other end of the pipe in a direction in which the cooling gas flows, in such a manner that the pipe inserted through the pipe insertion hole is fitted into the pipe-fitted hole in a state where the pipe forms a ring so as to surround the plant.

8. The plant cooling apparatus as set forth in claim 1, wherein:
a connecting section for connecting the cooling gas supply source with each of the at least one cooling gas supplying section includes at least one flexible pipe.

9. The plant cooling apparatus as set forth in claim 8, wherein:
the connecting section includes a branch section which (i) causes a passage of the cooling gas, which is supplied from the cooling gas supply source to each of the at least one cooling gas supplying section, to branch, and (ii) is provided with the at least one flexible pipe; and
each of the at least one cooling gas supplying section is connected with a corresponding one of the at least one flexible pipe connected with the branch section.
